(19) United States
(12) Patent Application Publication
(10) Pub. No.: US 2004/0105142 A1
(43) Pub. Date: Jun. 3, 2004

(54) Wavelength switching devices

(76) Inventor: Robert I Scott, Edinburgh (GB)

Correspondence Address: Nixon & Vanderhye, 8th Floor, 1100 North Glebe Road, Arlington, VA, 22201-4714, US

(21) Appl. No.: 10/473,429

(22) PCT Filed: May 3, 2002
(86) PCT No.: PCT/GB02/02036

(30) Foreign Application Priority Data
May 4, 2001 (GB) 0110968.5

(51) Int. Cl. G02F 2/02; G02F 1/35

(52) U.S. Cl. 359/326

(57) ABSTRACT

Described herein is optical apparatus (10) including switching apparatus (22, 24) for switching a beam between a first optical path (12) and a second optical path (14). The switching apparatus (22, 24) includes means (22) for altering the polarisation of the beam in accordance with an applied voltage, and means (24) for directing the beam along either the first optical path (12) or the second optical path (14) in accordance with its polarisation.

The present invention relates to improvements in or relating to wavelength switching devices.

Apparatus for illuminating items with laser radiation, are often required to transmit radiation having specific polarisations and wavelength. For example, it may be desirable to illuminate targets with horizontally polarised radiation of 1064 nm. Although this is possible, radiation of 1064 nm is not considered to be ‘eye-safe’ and therefore to enable the apparatus be fielded or trialled, the apparatus must be capable of generating a second wavelength of radiation that is ‘eye-safe’, for example radiation of 1500 nm.

Conventional wavelength switching devices used in optical apparatus to switch a beam from one wavelength to another involve moving parts and therefore require space to allow operation of these parts as they move from one position to another.

It is an object of the present invention to provide a wavelength switching device which does not require any moving parts.

In accordance with one aspect of the present invention, there is provided switching apparatus for altering the wavelength of radiation generated from a first wavelength to a second wavelength, comprising a voltage sensitive crystal and radiation modifying means, the radiation modifying means acting to alter the wavelength of the radiation in accordance with the polarisation of the radiation emitted by the voltage sensitive crystal

In accordance with another aspect of the present invention, there is provided a method of switching a transmitted beam between a first and a second wavelength, the method comprising the step of altering the polarisation of the beam in accordance with the desired wavelength.

Advantageously, the means for altering the polarisation of the beam comprises a voltage sensitive crystal.

Preferably, the voltage sensitive crystal comprises an electro-optic crystal, for example, a LiNbO₃ crystal.

In one embodiment of the invention, polarisation sensitive means are provided for directing the beam along the first or second optical path in accordance with its polarisation.

The switching device of the present invention allows a laser beam to be directed onto an optical path in which the beam may be altered, for example, by having its wavelength changed.

In a second embodiment of the invention, polarisation sensitive means are provided that allow a laser beam to be altered in accordance with its transmission polarisation, allowing a beam having differently polarised components with different wavelengths to be generated and switched accordingly.

For a better understanding of the present invention, reference will now be made, by way of example only, to the accompanying drawings in which:—

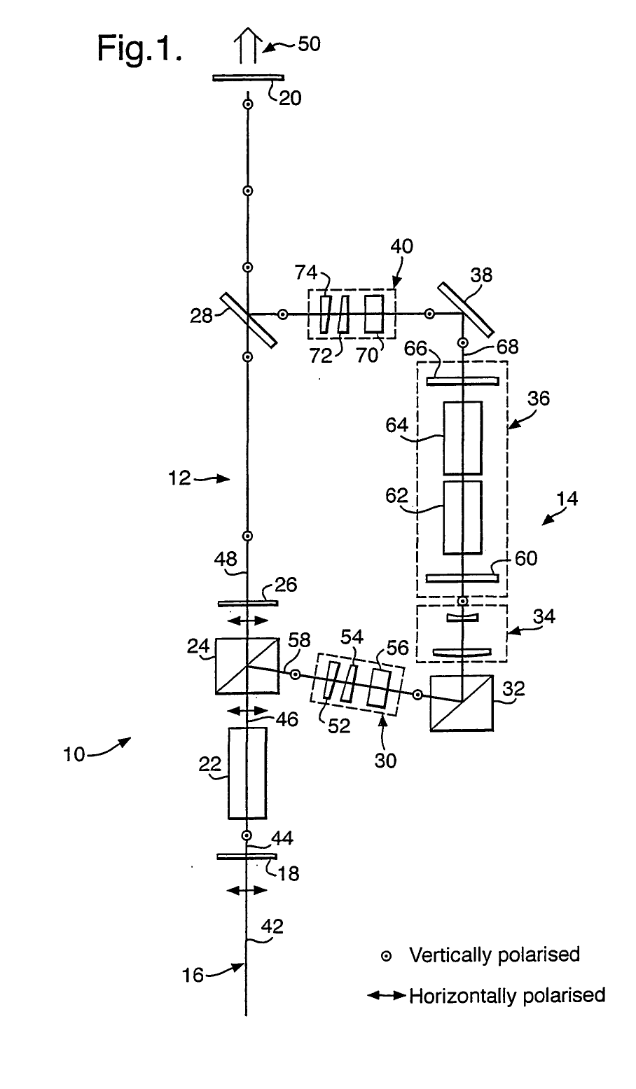

FIG. 1 illustrates optical apparatus in accordance with the present invention;

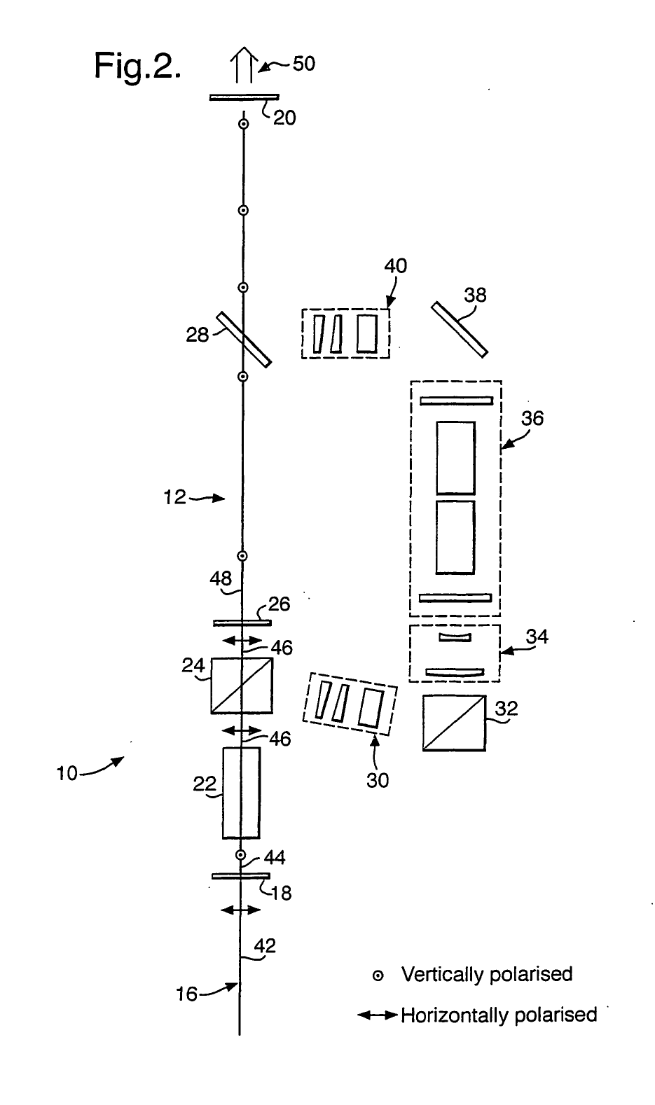

FIG. 2 illustrates a first optical path through the FIG. 1 apparatus;

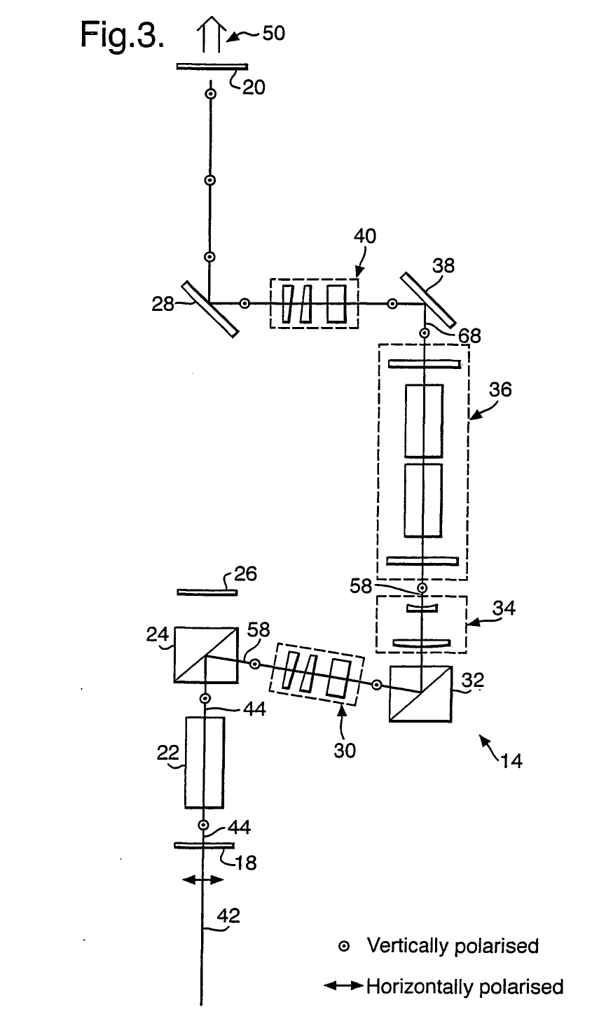

FIG. 3 illustrates a second optical path through the FIG. 1 apparatus;

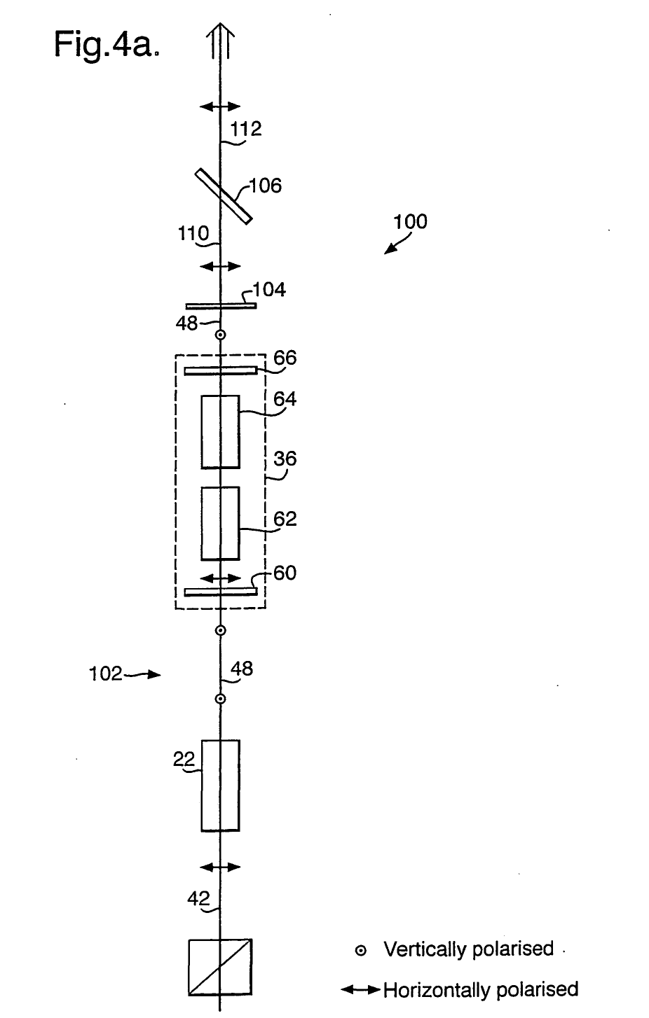

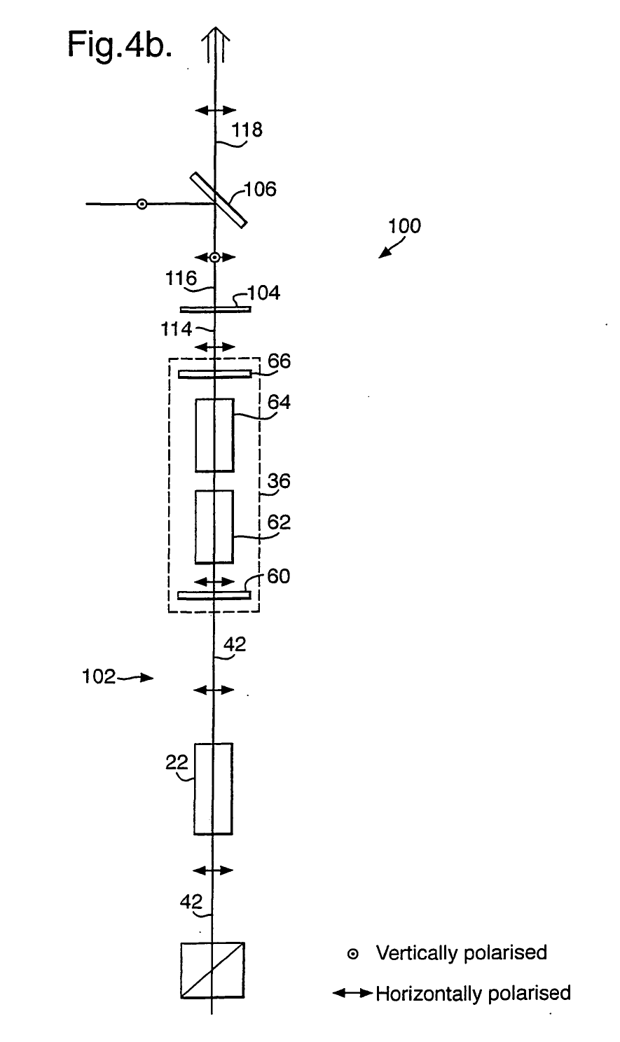

FIGS. 4a and 4b illustrate a wavelength switching device in accordance with a second embodiment of the present invention.

Referring initially to FIG. 1, optical apparatus 10 is shown which has two possible optical paths 12, 14. Optical path 12 coincides with an optical axis 16 which passes through waveplates 18, 20. Also on optical axis 16 are a LiNbO₃ crystal 22, a polariser cube 24, a further waveplate 26 and a dichroic beamsplifter 28. Operation of these components will be described in detail later. Optical path 14 includes polariser cube 24, steering optics 30, a second polariser cube 32, a telescope 34, beam modifying means 36, a mirror 38, second steering optics 40 and dichroic beamsplitter 28. Polariser cube 32 may be replaced by a prism, mirror or other suitable reflector. Similarly, mirror 38 may be replaced by a polariser cube, prism or other suitable reflector.

Waveplate 18 operates to convert an input laser beam 42 having a horizontal polarisation into a beam 44 having a vertical polarisation. The terms horizontal and vertical polarisation are relative terms and relate to planes of polarisation which are orthogonal to one another and which can be considered to be in the plane of the page and in the plane orthogonal thereto respectively. These planes of polarisations are illustrated by double-ended arrows and a circle with a dot in it respectively in the figures.

LiNbO₃ crystal 22 operates to change the polarisation of beam 44 when it has a voltage applied to it. This means that beam 46 exiting the crystal 22 may either be horizontally polarised or vertically polarised. Polariser cube 24 operates either to transmit beam 46 towards waveplate 26 or to reflect beam 46 towards steering optics 30 on path 14 in accordance with the polarisation of beam 46 as will be described in more detail with reference to FIGS. 2 and 3.

Beam 46 when transmitted through polariser cube 24 passes to waveplate 26 where its polarisation is changed from horizontally polarised to vertically polarised to form beam 48. Beam 48 is transmitted by dichroic beamsplitter 28 towards output waveplate 20. Waveplate 20 is adjustable to vary the output polarisation of the exit beam 50.

In optical path 14, steering optics 30 comprises wedges 52, 54 and an optical micrometer 56. Beam 58 reflected by polariser cube 24 passes through steering optics 30 onto polariser cube 32, through telescope 34 to beam modifying means 36. Telescope 34 is a reverse telescope. Beam modifying means 36 comprises an optical parametric oscillator (OPO) input mirror 60, OPO non-linear crystals 62, 64 and an OPO output coupler 66. The OPO non-linear crystals 62, 64 may comprise potassium titanyl arsenate (KTA) or potassium titanyl phosphate (KTP). Modified beam 68 existing the beam modifying means 36 is reflected by mirror 38 into steering optics 40 and onto dichroic beamsplitter 28. Mirror 38 may be replaced by a directing prism as described above. Steering optics 40 is similar to steering optics 30 and comprises an optical micrometer 70 and wedges 72, 74. Dichroic beamsplitter 28 reflects beam 68 onto optical axis 16 and hence to output waveplate 20.

Operation of the optical apparatus 10 of the present invention will now be described in more detail with reference to FIGS. 2 and 3. Items which have been described previously in FIG. 1 are referenced the same.

Referring now to FIG. 2 which shows optical path 12 in more detail, input laser beam 42 has a wavelength of 1.064 μm and is transmitted along optical axis 16 in a substantially straight line as shown. This is achieved because LiNbO₃ crystal 22 has a voltage applied to it so that it changes the polarisation of beam 44 passing through it from vertically polarised to horizontally polarised to form beam 48.

As described with reference to FIG. 1, beam 42 (horizontally polarised) has its polarisation changed by waveplate 18 to form beam 44 (vertically polarised). Beam 44 has its polarisation changed back to horizontally polarised in beam 46 by crystal 22. Polariser cube 24 transmits the horizontally polarised beam 46 to waveplate 26 where it is changed to beam 48 which is vertically polarised. Dichroic beamsplitter 28 transmits beam 48 to output waveplate 20 to provide output beam 50 having a wavelength of 1.064 μm and having a final polarisation determined by waveplate 20.

Turning now to FIG. 3 which shows optical path 14 in more detail, input laser beam 42 has a wavelength of 1.064 μm and is horizontally polarised. After passing through waveplate 18, beam 42 becomes beam 44 which is vertically polarised. Beam 44 passes to crystal 22 and is transmitted therethrough with no change in its polarisation as crystal 22 has no voltage supplied thereto. Because beam 44 is vertically polarised, it is not transmitted by polariser cube 24 but is reflected onto optical path 14 as beam 58. Beam 58 maintains its polarisation through path 14 as it passes through steering optics 30, is reflected by polariser cube 32, and passes through telescope 34 into beam modifying means 36. Beam modifying means 36 changes the wavelength of beam 44 to form beam 68 which has a wavelength of 1.5 μm but is still vertically polarised. Beam 68 is reflected by mirror 38, passes through steering optics 40, and is reflected by dichroic beamsplitter 28 towards waveplate 20. As before, output beam 50 is polarised in accordance with waveplate 20 but has a wavelength of 1.5 μm.

It will readily be understood that in the optical apparatus 10 described above, switching between the two optical paths is achieved by LiNbO₃ crystal 22 which changes the polarisation of the beam passing through it to direct the beam along the first optical path 12 and does not change the polarisation to direct the beam along the second optical path 14.

Although the described embodiment of the present invention relates to changing the wavelength of a beam passing along the second optical path, it will be appreciated that the second optical path can be used for other operations. For example, the second optical path could be used to monitor the beam or for sampling signals carried by the beam. The only requirement is that a change in polarisation of a beam is used to switch it between two optical paths.

Operation of the optical apparatus 100 of a second embodiment of the present invention will now be described in more detail with reference to FIGS. 4a and 4b. Items which have been described previously in FIGS. 1, 2 and 3 are referenced the same.

Referring to FIGS. 4a and 4b, optical apparatus 100 is shown which has only a single optical path 102. On the optical path, which coincides with the optical axis, are a LiNbO₃ crystal 22, beam modifying means 36, a waveplate 104 and a dichroic beamsplitter 106.

Waveplate 104 operates to convert an input laser beam having a vertical polarisation into a beam having a horizontal polarisation. The terms horizontal and vertical polarisation are relative terms and relate to planes of polarisation which are orthogonal to one another and which can be considered to be in the plane of the page and in the plane orthogonal thereto respectively. Again, these planes are illustrated by double ended arrows and a circle with a dot in it respectively.

LiNbO₃ crystal 22 operates to change the polarisation of beam 44 when it has a voltage applied to it. This means that a beam exiting the crystal 22 may either be horizontally polarised or vertically polarised.

A horizontally polarised laser beam 42 of 1064 nm wavelength is transmitted through the crystal 22 where, due to the application of ½ wave voltage to the crystal 22, its polarisation is changed from horizontally polarised to vertically polarised to form beam 48. The beam 48 is then transmitted through the beam modifying means 36, which comprise an optical parametric oscillator (OPO) input mirror 60, OPO non-linear crystals 62, 64 and an OPO output coupler 66. The OPO non-linear crystals 62, 64 may comprise potassium titanyl arsenate (KTA) or s potassium titanyl phosphate (KTP). As the beam 48 is vertically polarised, the beam modifying means 36 has no effect on the beam 48 and a beam of 1064 nm is transmitted to the waveplate 104. The waveplate 104 acts to change the polarisation of the beam 48 from vertically polarised to a horizontally polarised beam 110. Beam 110 exiting the waveplate 104 is incident on the dichroic beamsplitter which acts to transmit horizontally polarised beam 112, having a wavelength of 1064 nm.

Considering the apparatus shown in FIG. 4b, where no voltage is applied to the crystal 22, input laser beam 42 has a wavelength of 1064 nm and is horizontally polarised. Beam 42 passes to crystal 22 and is transmitted therethrough with no change in its polarisation as crystal 22 has no voltage supplied thereto. Beam 42 exits the crystal 22 and passes into beam modifying means 36. As the beam 42 is horizontally polarised, beam modifying means 36 changes the wavelength of beam 42 to form beam 114 which has a wavelength of 1500 nm but is still horizontally polarised. However, beam 114 also has a component of wavelength 1064 nm, which is also horizontally polarised. Beam 114 is passed to waveplate 104 which acts to change the 1064 nm wavelength component from being horizontally polarised to vertically polarised, whilst allowing the horizontally polarised 1500 nm component to pass therethrough and retain its horizontal polarisation. The beam 116 exiting the waveplate 104 therefore comprises two wavelength components having different polarisations. Beam 116 is passed to dichroic beamsplitter 106 that transmits the horizontally polarised 1500 nm component of beam 116, forming an output beam 118, whilst reflecting the vertically polarised 1064 nm component.

In this way, the same apparatus can be used to transmit different wavelengths of laser radiation, depending on the voltage applied to the LiNbO₃ crystal.

Polariser cubes 24, 32, steering optics 30, 40, telescope 34 and dichroic beamsplitter 28 are components conventionally used in optical apparatus. Furthermore, the beam altering means 36 may be replaced with similar components which provide a different change in wavelength or which change the beam in some other way.

It will be appreciated that the embodiments described in detail above use specific examples of crystal 22, waveplates and dichroic beamsplitters. These components may be replaced with similar components which provide different specific changes in transmission or reflection properties, for example. Waveplates capable of introducing different phase changes are known and may be used in place of those described above to provide differently polarised beams.

1. Switching apparatus for altering the wavelength of radiation generated from a first wavelength to a second wavelength, comprising a voltage sensitive crystal and radiation modifying means, the radiation modifying means acting to alter the wavelength of the radiation in accordance with the polarisation of the radiation emitted by the voltage sensitive crystal.

2. Apparatus according to claim 1 further comprising means for differentiating between radiation of first and second wavelength according to the polarisation of the radiation components having said first and second wavelengths.

3. Apparatus according to claim 1 or 2 further comprising means for diverting said second wavelength component when said first wavelength component is transmitted.

4. Apparatus according to claim 3, wherein the means for altering the polarisation of the beam comprises a voltage sensitive crystal.

5. Apparatus according to claim 4, where in the voltage sensitive crystal comprises an electro-optic crystal.

6. Apparatus according to claim 5, wherein the electro-optic crystal comprises a LiNbO₃ crystal.

7. A method of switching a transmitted beam between a first and a second wavelength, the method comprising the step of altering the polarisation of the beam in accordance with the desired wavelength.

8. A method of switching a beam between a first and a second optical path, the method comprising the step of altering the polarisation of the beam in accordance with the desired optical path.

9. Switching apparatus for switching a beam between a first and a second optical path, the apparatus comprising means for altering the polarisation of the beam in accordance with the desired optical path.

10. Apparatus according to claim 9, wherein the means for altering the polarisation of the beam comprises a voltage sensitive crystal.

11. Apparatus according to claim 10, where in the voltage sensitive crystal comprises an electro-optic crystal.

12. Apparatus according to claim 11, wherein the electro-optic crystal comprises a LiNbO₃ crystal.

13. Apparatus according to any one of claims 9 to 12, further including polarisation sensitive means for directing the beam along the first or second optical path in accordance with its polarisation.

14. Apparatus according to any one of claims 9 to 13, wherein the means for altering the polarisation of the beam changes the polarisation from one plane to an orthogonal plane.

14. A method of switching a beam between a first and a second optical path substantially as hereinbefore described with reference to FIGS. 1 to 3 of the accompanying drawings.

15. Switching apparatus substantially as hereinbefore described with reference to FIGS. 1 to 3 and FIGS. 4a and 4b accompanying drawings.

16. A method of switching a beam between a first and a second wavelength as hereinbefore described with reference to FIGS. 4a and 4b of the accompanying drawings.
